(19) United States
(12) Patent Application Publication
(10) Pub. No.: US 2019/0033617 A1
(43) Pub. Date: Jan. 31, 2019

(54) METHOD FOR PRODUCING ANTI-FOG LENS

(71) Applicant: Dongguan Longwell Sports Co., Ltd., Dongguan City (CN)

(72) Inventor: Chin-Hsien Wung, Dongguan City (CN)

(21) Appl. No.: 16/040,544

(22) Filed: Jul. 20, 2018

(30) Foreign Application Priority Data
Jul. 28, 2017 (CN) 201710631686.8

(51) Int. Cl. G02C 7/02; G02B 27/00; G02B 1/14; G02B 1/18; B29D 11/00

(52) U.S. Cl. CPC G02C 7/02; G02B 27/0006; B29D 11/00865; G02B 1/18; G02B 1/14

(57) ABSTRACT

A method for producing an anti-fog lens, comprising the steps of: (1) anti-fog liquid preparation: 6.8-10 parts by mass of glass anti-fog coating and 0.68-1 parts by mass of diluent being poured into a container and thoroughly mixed to obtain an anti-fog liquid; (2) dripping the anti-fog liquid; (3) baking; and (4) cooling. When the anti-fog lens produced by the method is used, the surface of the lens will not mist up, which is convenient for use.

### BACKGROUND OF THE INVENTION

### 1. Field of the Invention

The present invention relates to a lens, and in particular to a method for producing an anti-fog lens.

### 2. Description of the Prior Art

In daily life, people (especially women) generally pay more attention to eye care and maintenance. For example, women with single-edged eyelids will go to the hospital or beauty salon to cut double-fold eyelids or embed an invisible line in the upper eyelid to form artificial double-fold eyelids. These are the specific needs and performances that people pursue eye beauty. People also put forward anti-fog requirements for the glasses they wear. When the glasses make contact with a source of warm/hot air or in the case of the transition from a cold environment into a warm environment (for example, entering the home from outside in cold temperatures in the winter), the wearer hopes that the surfaces of the glasses will not mist up. Accordingly, the inventor of the present invention has devoted himself based on his many years of practical experiences to solve these problems.

### SUMMARY OF THE INVENTION

In view of the drawbacks of the prior art, the primary object of the present invention is to provide a method for producing an anti-fog lens, which can effectively prevent fogging of the lens.

In order to achieve the aforesaid object, the present invention adopts the following technical solutions:

A method for producing an anti-fog lens, comprising the steps of (1) anti-fog liquid preparation: 6.8-10 parts by mass of glass anti-fog coating and 0.68-1 parts by mass of diluent being poured into a container and thoroughly mixed to obtain an anti-fog liquid, the anti-fog liquid being sealed and stored in an environment of 5-7° C.;

(2) dripping the anti-fog liquid: a special lens fixture being first cleaned, and then a lens to be produced being installed, a dust-free cloth being added with anhydrous alcohol to gently wipe an anti-fog surface of the lens by hand to make the surface of the lens clean; after that, the anti-fog liquid being poured into a funnel, the left hand being to grip a drip switch, the right hand being to place the lens in a corresponding position for dripping the required anti-fog liquid, the anti-fog liquid flowing to an inner edge of the lens, the lens being oscillated horizon ally by hand to make the anti-fog liquid flow evenly within the surface of the lens;

(3) baking: after a baking line is heated to have a temperature of 136-140° C., the lens dripped with the anti-fog liquid in step (2) being fully inspected and then placed into an oven of the baking line;

(4) cooling: after the lens is output from the baking line, the lens being taken by hand with a towel, and the lens being placed on a workbench for cooling.

Preferably, in the step (1), a stirrer is used to mix the glass anti-fog coating and the diluent evenly, and the stirrer is turned on to stir the glass anti-fog coating and the diluent for 15-20 minutes at a speed of 20 revolutions per second.

Preferably, in the step (3), the baking line is operated at a speed of less than 60 minutes per revolution.

Preferably, the method further comprising the step (5) of packing: after a product is cooled, an operator wears white gloves to take out the product for inspection, visually checking whether there are impurities and flow lines on the product. If no, the product is packed.

The present invention has obvious advantages and beneficial effects compared with the prior art. Specifically, it can be known from the above technical solutions:

When the anti-fog lens produced by the method of the present invention, comprising the steps of anti-fog liquid preparation, dripping the anti-fog liquid, baking and cooling, makes contact with a source of warm/hot air or in the case of the transition from a cold environment into a warm environment (for example, entering the home from outside in cold temperatures in the winter), the surface of the lens will not mist up, which is convenient for use.

### BRIEF DESCRIPTION OF THE DRAWINGS

FIG. 1 is a flow chart of the method for producing an anti-fog lens according to a preferred embodiment of the present invention.

### DETAILED DESCRIPTION OF THE PREFERRED EMBODIMENTS

Embodiments of the present invention will now be described, by way of example only, with reference to the accompanying drawings.

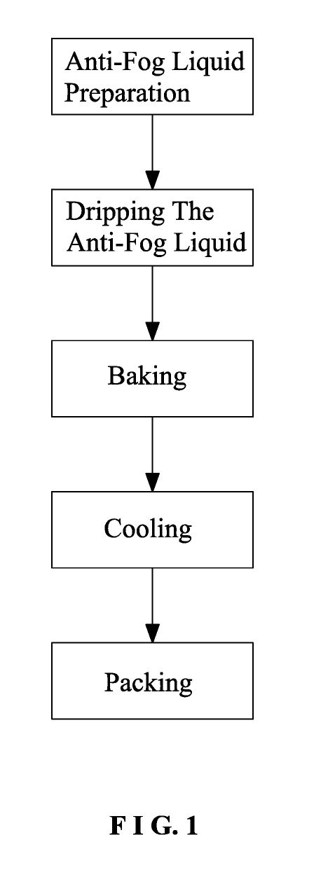

Referring to FIG. 1, the present invention discloses a method for producing an anti-fog lens. The method comprises the steps of (1) anti-fog liquid preparation: 6.8-10 parts by mass of glass anti-fog coating and 0.68-1 parts by mass of diluent are poured into a container and thoroughly mixed to obtain an anti-fog liquid. The anti-fog liquid is sealed and stored in an environment of 5-7° C. A stirrer is used to mix the glass anti-fog coating and the diluent evenly. The stirrer is turned on to stir the glass anti-fog coating and the diluent for 15-20 minutes at a speed of 20 revolutions per second, so that the glass anti-fog coating and the diluent are mixed very evenly and thoroughly before use. For the environmental conditions, the indoor temperature must be less than 30° C. and the humidity is less than 50%. The glass anti-fog coating and the diluent after stirred and mixed are placed still for 10 minutes until there is no bubble at all for use. The ratio of the anti-fog liquid after recovery is 10:1 (that is, 10 g recovered anti-fog liquid to 1 g diluent). The anti-fog liquid must be sealed and stored in a refrigerator at a temperature of 5-7° C. After recovery, the anti-fog liquid is valid for 168 hours, 7 days.

(2) dripping the anti-fog liquid: A special lens fixture is first cleaned, and then a lens to be produced is installed. A dust-free cloth is added with anhydrous alcohol to gently wipe an anti-fog surface of the lens by hand to make the surface of the lens clean. After that, the anti-fog liquid is poured into a funnel. The left hand is to grip a drip switch, and the right hand is to place the lens in a corresponding position for dripping the required anti-fog liquid. The anti-fog liquid flows to an inner edge of the lens, and the lens is oscillated horizon ally by hand to make the anti-fog liquid flow evenly within the surface of the lens. For the environmental conditions, the indoor temperature must be less than 30° C., and the humidity is less than 50%.

(3) baking: After a baking line is heated to have a temperature of 136-140° C., the lens dripped with the anti-fog liquid in step (2) is fully inspected and then placed into an oven of the baking line. The baking line is operated at a speed of less than 60 minutes per revolution. When the product is sent to the baking line, the baking line cannot be stopped, and the baking time of the oven must reach the predetermined time. Before the baking line is closed every day, all the products in the oven must be taken out and then the power can be turned off.

(4) cooling: After the lens is output from the baking line, the lens is taken by hand with a towel, and the lens is placed on a workbench for cooling, and the cooling is air-cooled.

(5) packing: After the product is cooled, the operator wears white gloves to take out the product for inspection, visually checking whether there are impurities and flow lines on the product. If no, the product can be packed.

An anti-fog test is performed for the lens produced by the above method. When the product is moved from the environment of minus 10° C. to the side of warm water of 45-50°, the surface of the lens will not mist up.

The feature of the present invention is that when the anti-fog lens produced by the method of the present invention, comprising the steps of anti-fog liquid preparation, dripping the anti-fog liquid, baking and cooling, makes contact with a source of warm/hot air or in the case of the transition from a cold environment into a warm environment (for example, entering the home from outside in cold temperatures in the winter), the surface of the lens will not mist up, which is convenient for use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A method for producing an anti-fog lens, comprising the steps of:
(1) anti-fog liquid preparation: 6.8-10 parts by mass of glass anti-fog coating and 0.68-1 parts by mass of diluent being poured into a container and thoroughly mixed to obtain an anti-fog liquid, the anti-fog liquid being sealed and stored in an environment of 5-7° C.;
(2) dripping the anti-fog liquid: a special lens fixture being first cleaned, and then a lens to be produced being installed, a dust-free cloth being added with anhydrous alcohol to gently wipe an anti-fog surface of the lens by hand to make the surface of the lens clean; after that, the anti-fog liquid being poured into a funnel, a left hand being to grip a drip switch, a right hand being to place the lens in a corresponding position for dripping the required anti-fog liquid, the anti-fog liquid flowing to an inner edge of the lens, the lens being oscillated horizon ally by hand to make the anti-fog liquid flow evenly within the surface of the lens;
(3) baking: after a baking line is heated to have a temperature of 136-140° C., the lens dripped with the anti-fog liquid in step (2) being fully inspected and then placed into an oven of the baking line;
(4) cooling: after the lens is output from the baking line, the lens being taken by hand with a towel, and the lens being placed on a workbench for cooling.

2. The method as claimed in claim 1, wherein in the step (1), a stirrer is used to mix the glass anti-fog coating and the diluent evenly, and the stirrer is turned on to stir the glass anti-fog coating and the diluent for 15-20 minutes at a speed of 20 revolutions per second.

3. The method as claimed in claim 1, wherein in the step (3), the baking line is operated at a speed of less than 60 minutes per revolution.

4. The method as claimed in claim 1, further comprising the step (5) of packing: after a product is cooled, an operator wears white gloves to take out the product for inspection, visually checking whether there are impurities and flow lines on the product, if no, the product being packed.
